(19) United States
(12) Patent Application Publication
(10) Pub. No.: US 2004/0074420 A1
(43) Pub. Date: Apr. 22, 2004

(54) Substrate treatment

(76) Inventor: John Michael Edmunds, Wales (GB)

Correspondence Address: NIXON & VANDERHYE, PC, 1100 N GLEBE ROAD, 8TH FLOOR, ARLINGTON, VA, 22201-4714, US

(21) Appl. No.: 10/467,929

(22) PCT Filed: Feb. 13, 2002
(86) PCT No.: PCT/GB02/00661

(30) Foreign Application Priority Data
Feb. 14, 2001 (GB) 0103553.4

(51) Int. Cl. C08L 89/00

(52) U.S. Cl. 106/157.2; 106/400; 106/481; 106/482; 106/401; 106/483; 106/160.1; 106/287.17; 106/287.34; 106/157.7; 106/157.8

(57) ABSTRACT

A substrate treatment composition comprising a particulate substrate treating agent (other than precipitated calcium carbonate), wherein the particles of the substrate treating agent, such as silica, organosilane, aluminium oxide or hydroxide have a broad range of diameters and include at least some particles with a diameter greater than 0.9 μm and at least some particles with a diameter less than 0.5 μm. Suitable substrates include paper, fabrics, plastics and glass which are subsequently printed on.

### FIELD OF THE INVENTION

This invention relates to substrate treatment compositions, to substrates treated with the compositions and to methods of substrate production and/or treatment.

### BACKGROUND TO THE INVENTION

Substrates such as paper and fabric usually need to be surface treated before they can be printed on. The treatment, applied as a coating to either or both surfaces of the substrate, renders it more receptive to applied inks, and hence reducing the risk of ink “spreading” which can lower print resolution.

Techniques for applying such coatings are already known and in common use. A substrate may be coated “inline”, as a final step in its manufacture, or “offline” as a separate process subsequent to its manufacture. In the case of a paper substrate, the ink-receptive coating is applied separately to, and after, the application of a “sizing” composition, which modifies the paper surface according to the desired finish.

The type of coating and the way in which it is applied depend on the nature of the substrate, the ink and the intended printing process, as well as on the intended use of the final printed product. For instance, for a paper substrate intended to be ink jet printed, conventionally used coatings are almost all resin-based. Such coatings are however incompatible with laser printing. There is as yet no “universal” coating which can be applied to a substrate to render it compatible with a wide range of printing techniques.

Resin-based coatings can bring their own processing problems, due to the organic solvents with which they have to be formulated. A non-resinous, silica-based coating has more recently become available for paper treatment, but with limited success so far. Silica based coatings are described for example in U.S. Pat. No. 5,804,293.

WO 98/51860 describes aragonitic precipitated calcium carbonate pigment of various particle sizes for coating rotogravure printing papers.

As an alternative to surface coating, it would be desirable to impregnate a substrate with a treatment composition. The treatment process could thereby be simplified, requiring only immersion of the substrate in the treatment composition rather than a more complex coating operation which may need to be carried out on both sides of the substrate. Clay-based impregnating compositions are known, but tend to give relatively low resolution when the treated substrate is printed on. It has not so far been possible to impregnate a substrate with a resin-based treatment composition, such as might be needed for ink jet printer paper.

Embodiments of the present invention can provide improved substrate treatment compositions and processes, in particular but not exclusively compatible with ink jet printing, which overcome or at least mitigate the above described problems.

### SUMMARY OF THE INVENTION

According to a first aspect of the present invention, there is provided a substrate treatment composition comprising a particulate substrate treating agent, wherein the particles of the substrate treating agent have a broad range of diameters and include at least some particles with a diameter greater than 0.9 μm (preferably greater than 1 μm) and at least some particles with a diameter less than 0.5 μm. Preferably the agent also includes at least some particles with a diameter of between 0.5 and 0.9 μm.

As used herein the expression “substrate treating agent” means any agent with which a substrate is to be treated, especially to modify its surface and/or internal properties for instance in preparation for subsequent printing, but excluding precipitated calcium carbonate (PCC). Examples of substrate treating agents are silica (SiO₂), organosilanes (such as those conventionally used in coatings) aluminium compounds such as alumina or particulate aluminium oxide Al₂O₃ or hydrated forms thereof, and in particular aluminium hydroxide, Al(OH)₃, or aluminium hydroxy halides such as aluminium hydroxy chloride, aluminium carbonates, zircon sulphates and zircon carbonates.

The organosilanes used will be of formula Si(R¹R²R³R⁴) where R¹, where R¹, R², R³ and R⁴ are independently selected from hydrogen or an organic group, such as an optionally substituted hydrocarbyl group or optionally substituted heterocyclic group. The term “hydrocarbyl” refers to any structure comprising carbon and hydrogen atoms. For example, these may be alkyl, alkenyl, alkynyl, aryl such as phenyl or napthyl, arylalkyl, cycloalkyl, cycloalkenyl or cycloalkynyl. Suitably they will contain up to 20 and preferably up to 10 carbon atoms.

As used herein, the term “alkyl” refers to straight or branched chain alkyl groups, suitably containing up to 20 and preferably up to 6 carbon atoms. The term “alkenyl” and “alkynyl” refer to unsaturated straight or branched chains which include for example from 2-20 carbon atoms, for example from 2 to 6 carbon atoms. In addition, the term “aryl” refers to aromatic groups such as phenyl or naphthyl.

The term “heterocyclic” includes aromatic or non-aromatic rings, for example containing from 4 to 20, suitably from 5 to 10 ring atoms, at least one of which is a heteroatom such as oxygen, sulphur or nitrogen. Examples of such groups include furyl, thienyl, pyrrolyl, pyrrolidinyl, imidazolyl, triazolyl, thiazolyl, tetrazolyl, oxazolyl, isoxazolyl, pyrazolyl, pyridyl, pyrimidinyl, pyrazinyl, pyridazinyl, triazinyl, quinolinyl, iosquinolinyl, quinoxalinyl, benzthiazolyl, benzoxazolyl, benzothienyl or benzofuryl.

Suitable optional substituents for hydrocarbyl groups R¹, R², R³ and R⁴ are heterocylic groups or functional groups. Suitable optional substituents for heterocyclic groups R¹, R², R³ and R⁴ are hydrocarbyl groups or functional groups.

The term “functional group” refers to reactive groups such as halo, cyano, nitro, oxo, C(O)ₙR^{a}, OR^{a}, S(O)ₜR^{a}, NR^{b}R^{c}, OC(O)NR^{b}R^{c}, C(O)NR^{b}R^{c}, OC(O)NR^{b}R^{c}, —NR⁷C(O)ₙR⁶, —NR^{a}CONR^{b}R^{c}, —C=NOR^{a}, —N═CR^{b}R^{c}, S(O)ₜNR^{b}R^{c} or —NR^{b}S(O)ₜR^{a} where R^{a}, R^{b} and R^{c} are independently selected from hydrogen or optionally substituted hydrocarbyl, or R^{b} and R^{c} together form an optionally substituted ring which optionally contains further heteroatoms such as S(O)ₛ, oxygen and nitrogen, t is an integer of 1 or 2, s is 0 or an integer of 1-2, and any nitrogen atom may be protonated to form a quaternary ammonium salt.

Preferably, at least one of R¹, R², R³, or R⁴ includes a functional substituent with is cationic in nature, such as a quaternary ammonium group. A wide variety of different groups R¹, R², R³, or R⁴ may be used provided that the compound is a solid particulate material with the desired particle size.

The substrate treating agent is preferably in aqueous solution.

The particle size distribution for the substrate treating agent may be a single broad distribution ranging from 0.5 μm or below to 0.9 μm, preferably 1 μm, or greater. More conveniently, however, it may be a multi-modal size distribution comprising two or more, preferably three or more, distinct peaks due to separate populations of particles having different average and/or maximum diameters. Suitably the ratio of the amount of particles below 0.5 μm to the amount in weight of particles greater than 0.9 μm diameter is in the range of 20:1 to 1:20, preferably from 10:1 to 1:10, more preferably from 5:1 to 1:5 and most preferably at about 1:1.

The use of a range of different particle sizes, in a substrate treatment composition, has been found to improve uniformity of application, In addition, the porosity and the mechanical durability of the substrate may be increased. This can ultimately lead to a higher print quality and faster drying capabilities when the treated substrate is printed or painted on. Depending upon the nature of the particles, water resistance and longevity of the substrate may also be improved.

Particle diameters may be measured by conventional means, such as are typically used to grade particulate agents in for instance the paper treatment industry. The sizes used in any particular treatment composition will depend on the intended end use of the treated substrate. For a smoother, more glossy finish, it is likely that smaller particles, for instance all below 1 μm, will be needed.

The substrate treatment agent is preferably silica, SiO2, most suitably an artificial rather than a natural (eg, fumed or precipitated) silica since natural silicas might typically provide a surface area of between 7 and 20 m²/cm³ whereas an artificial silica can provide much greater surface areas, for instance of at least 500 m²/cm³, even up to around 700 m²/cm³. The silica is preferably amorphous and preferably in the form of a gel.

Additionally or alternatively, the substrate treating agent may be particulate aluminium oxide Al₂O₃ or hydrated forms thereof, and in particular aluminium hydroxide, Al(OH)₃ again preferably in the form of a gel.

Where the substrate treating agent is, for example, silica, it conveniently has a multi-modal particle size distribution, i.e., it contains two or more distinct populations of particles having different maximum and/or mean diameters. It may for instance include two distinct populations of particles having maximum or mean diameters of (i) greater than 0.9 μm, preferably greater than 1 μm, such as 2, 3, 4 or 5 μm and (ii) less than 1 μm, preferably less than 0.5 μm, such as 0.3 or 0.2 μm.

More preferably it includes at least three populations of particles, which might typically have maximum or mean diameters of (i) between 1.2 and 10 μm, preferably between 2 and 8 μm, more preferably between 3 and 7 μm, such as 5 μm, (ii) between 0.5 and 1.2 μm, preferably between 0.8 and 1 μm, such as 1 μm and (iii) between 0.2 and 0.5 μm, such as 0.3 μm.

In a particular embodiment, the silica is present in three distinct populations, one with a mean diameter in the range of 4-10 μm, preferably 4-6 μm, one with a mean diameter in the range 0.9-1.3 μm and one with a mean diameter in the range of from 0.1-0.3 μm.

In a preferred embodiment, the third population may comprise an organosilane, and in particular a cationic organosilane and/or an aluminium compound such as aluminium hydroxychloride. A particularly suitable product for supplying the third population of particles is Sylojet® A-200, obtainable from Grace Davison (Europe). It may also include a further aluminium compound, such as aluminium hydroxide.

The ratio of the amounts of population (i) to population (ii) is suitably in the range of 5:1 to 1:5, more suitably from 1:1 to 1:3 and preferably about 1:2. The ratio of the amount of particles forming population (iii): populations (i) and (ii) is suitably from 3:1 to 1:6 and preferably about 1:2.5. A suitable ratio for population (i):(ii):(iii) is about 1:2:1.2.

A large number of particle populations may be included, for instance four or five or more. An example might be a blend of 5 particle populations with respective maximum or mean diameters of 1, 2, 3, 4 and 5 μm (ie, 1 μm steps above 1 μm) together with 3 groups of respective maximum or mean diameters 0.5, 0.4 and 0.3 μm (ie, 0.1 μm steps below 1 μm).

Where the substrate treating agent is or comprises aluminium hydroxide, it preferably has a mean particle diameter of between 0.01 and 5 μm, for example between 0.01 and 3 μm or 0.05 and 5 μm, preferably less than 1 μm, more preferably between 0.02 and 1 μm, most preferably between 0.02 and 0.8 μm. Its particle size distribution is preferably the same as or similar to that described above, i.e., it preferably includes at least some particles with a diameter greater than 0.9 or 1 μm and at least some particles with a diameter less than 0.5 μm; more preferably it also includes at least some particles with a diameter of between 0.5 and 0.9 or 1 μm. Again, the particle sizes are preferably broadly distributed between the upper and lower limits; conveniently a multi-modal size distribution may be used, as for the silica agent described above, for instance including one population having a maximum diameter of up to 0.5 μm and another having a maximum of up to 0.9 or 1 μm. In particular, for glossy finishes, where the substrate treatment agent includes aluminium hydroxide, the particle size is preferably in the range of from 0.1-0.7 μm.

The substrate for which the treatment composition of the invention is intended may be any substrate which may subsequently be printed on. It is preferably of a flexible material and in flat planar or “sheet” form. It may be porous or non-porous. Examples include paper (whether wood-based or otherwise), fabric (either natural or synthetic) and plastics films such as are used in packaging and glass. Clearly this list is not exhaustive. The substrate may already carry a surface coating or other treatment, such as a protective (for example, UV-resistant, fire resistant, water-proofing) or decorative (for example, metallic) coating.

In particular the substrate may be for use in printing including “aqueous” printing such as ink jet printing as well as non-aqueous printing or oil-based printing or painting methods.

In the context of the present invention, “treatment” means the application of a composition to a substrate (whether as a surface coating or by its incorporation into the substrate body by impregnation) so as to modify the properties of the substrate. Typically, the composition is applied so as to enhance the substrate receptivity to ink during a subsequent printing process, for instance by increasing the adherence of applied ink to the substrate surface and/or the stability of the applied ink and/or the printing resolution achievable on the substrate. Instead or in addition, it may act as a “sizing” agent for a substrate (in particular a paper) to which it is applied. In some cases, these can be effected without substantially changing the “feel” of the substrate.

In a preferred embodiment of the first aspect of the invention, the substrate treatment composition comprises (a) particulate silica of the type described above, (b) particulate aluminium hydroxide of the type described above and (c) water.

It has been found that such a treatment composition, containing both silica and alumina, can allow extremely high resolution during subsequent printing operations. Resolutions of up to 6,000 dpi have been achieved, even for fabric substrates. The silica particles afford an extremely high absorbency for a subsequently applied ink; the smaller the particles the greater the available surface area to which the ink can adhere. The print may also appear to have greater depth and clarity and may be considerably more durable (for instance, in terms of resistance to ultraviolet light, free radicals, detergents, etc.) than comparable prior art prints. Resistance to fading of most inks may also be increased, and the speed of drying of inks may be increases as compared to prior art prints.

More importantly, and surprisingly, it has been found that such a composition may be incorporated into, or embedded in, the body of a substrate such as paper or fabric. This can be expected to yield significant processing advantages. The composition may be applied to a substrate during the substrate manufacturing process, for instance instead of or combined with an already used treatment composition such as a paper sizing composition. The substrate production process can thus be more streamlined and involve fewer processing steps, with consequent savings in cost, complexity and waste. The ability to impregnate a substrate with a treatment composition potentially avoids two surface coating steps, since both sides of a substrate are, effectively, treated simultaneously.

In particular, it may be possible to use the treatment composition of the invention in place of a conventional paper sizing composition, to perform two paper treatments simultaneously.

Because the treatment composition of the invention can be water-based, it can be more environmentally friendly than conventional organic solvent containing resin-based treatments. It can be less toxic and also practically inert, making it ideal for the treatment of substrates, such as packaging films, which are intended for use with foodstuffs, pharmaceuticals and other consumable items.

A water base, and a substantial absence of organic solvents and resins, also means that the composition of the invention can be almost universally useable, i.e., compatible with most known printing processes, in particular ink jet but also, for example, offset printing and photogravure printing.

Moreover, the combination of the silica component (a) and the aluminium hydroxide component (b) has water-proofing properties. The treatment composition of the invention can therefore provide a water impermeable substrate surface, and a highly effective moisture barrier when embedded in the body of the substrate. The treated substrate may thus be used in moisture sensitive situations, such as to package foodstuffs and pharmaceuticals. It may also be printed with water-based inks, for which a special coating has often previously been needed.

The treatment composition of the invention is ideally applied either immediately after, or more preferably during, the manufacture of the substrate (i.e., “inline”). It may alternatively be applied during a separate, subsequent treatment process (“offline”).

The treatment composition may suitably be applied as a surface coating, using conventional techniques such as application using sizing rollers or the reverse gravure process. It may be applied to more than one surface of the substrate. In certain cases it may be incorporated into, or “embedded” in, the body of the substrate, for instance by immersing the substrate in the treatment composition. Embedding is thought to be particularly effective for paper substrates. Porous substrates are required for effective impregnation or embedding of the composition.

The treatment composition may be applied instead of a conventional sizing agent, for instance in the case of a paper substrate.

Silicas suitable for use in component (a) in the treatment composition of the invention are available in gel form from Grace Davison (a Division of W.R. Grace Inc, USA) under the registered trade mark Sylojet. Commercially available silicas such as these tend to contain a single particle population having a certain average diameter. For instance, Sylojet® P405 contains silica particles of average diameter 5 μm, Sylojet® 710C particles of mean diameter 1 μm. They are tightly filtered, so that although there may be some variation in the actual size of the particles, this is not very significant and the majority of particles are close to the mean size. Two or more such products, containing appropriate particle sizes, therefore need to be combined to produce a composition in accordance with the present invention.

These components may be combined with other silica formulations with an average particle size of less than 0.5 μm, for example of about 0.3 μm.

Suitably however, the small particle population is made up of other particle types such as organosilanes and/or alumina compounds. For instance Sylojet® A-200 supplied by Grace Davison, comprises particles of organosilane (and and alumina hydroxychloride, with a mean diameter 0.3 μm. Therefore this is a suitable reagent for supplying the third population of particles in the mixture (as well as for example, the aluminium hydroxide component (b) described above).

Such formulations may also contain minor amounts of other additives as outlined below. In particular, the formulations may include one or more binders. Particular binders include polyvinylalcohol (PVOH) (available for example from Air Products/DuPont), photographic gelatin (available from Kind & Knox, as well as Eastman), or acrylic latex (available for example from B.F. Goodrich, Rohm & Haas and BASF).

Where PVOH is present, it is preferably present in an amount of from 7 parts PVOH per hundred parts silica to 35 parts PVOH per hundred parts silica. Photographic gelatins are usually used in amounts of from 20-50 parts per hundred parts silica. They tend to be extremely hydrophilic, and can be insolublized to produce very water resistance substrates. Acrylic latex binders are generally used in amounts of from 5-100 parts per 100 parts silica, but may preferably be used as a co-binder in combination with PVOH. It increases resistance to u.v. light and so reduces yellowing of the substrate.

The aluminium hydroxide component (b) preferably contains particles of mean diameter less than 0.3 μm, more preferably less than 0.2 or 0.1 μm.

The alumina is thought to fulfil a number of functions in the treatment composition. It is believed to coat the silica particles and, because it is itself attracted to substrates such as acid-free paper, to help draw the silica into the body of the substrate. It can thus enhance interaction between the substrate and the treatment composition, leading to more durable coatings. In many cases it can facilitate penetration of the substrate by the silica, allowing the treatment composition of the invention to be embedded into the substrate body in a way that existing resin-based compositions cannot.

A suitable component (b), containing Al(OH)₃ and minor amounts of PVOH, is available as a by-product of the etching of aluminium substrates in caustic soda, for instance from Kyowa Chemical Industries Co., (Japan). Dried aluminium hydroxide gels of suitable particle sizes may also be obtained from Pennine Darlington Magnesia (UK).

The component (b) may contain minor amounts of other ingredients, for instance aluminium sulphate.

The treatment composition of the invention is ideally water-based, containing water as the major solvent and being substantially or completely free of organic solvents. In particular it preferably contains few or no resinous materials which are not water soluble (ideally less than 1% w/w, better still less than 0.5 or even 0.2 or 0.1% w/w). Where resins are present, these are preferably water soluble resins such as PVOH mentioned above. The amount of water present is preferably such as to give an active ingredient (e.g., silica (a) and/or alumina (b)) concentration of between 10 and 80% w/w, preferably between 20 and 60% w/w, more preferably between 20 and 30% w/w.

A treatment composition according to the invention may contain additional ingredients as well as components (a) and/or (b). The natures and quantities of such additional ingredients will depend on the nature of the substrate to which, and manner in which, the treatment composition is to be applied and on the nature of the printing process with which the substrate is intended to be used. They may include materials used in conventional treatment compositions for the relevant substrate, for instance viscosity regulators, binders, anti-foaming agents, dispersion regulators, dye fixing mordants, and stabilisers. Particular binders include PVOH (available for example from Air Products/DuPont), photographic gelatin (available from Kind & Knox, as well as Eastman), or acrylic latex (available for example from B.F. Goodrich, Rohm & Haas and BASP) as outlined above. Another possible binder would be an ionic hyperbranched polyesteramide such as that available from DSM (Netherlands) as “PreTop”. This may also act as a mordant, to increase the depth of colour possible.

However, the level of resins such as PVOH should ideally be kept below 1% w/w, preferably below 0.1% w/w.

Other optional ingredients include cationic surfactants, in particular poly(quaternary ammonium) compounds such as poly(diallyldimethyl ammonium chloride) (“poly-DADMAC”), and/or poly(dimethyl epichlorohydrin) (“poly-DMA-EPI”), quaternised vinylpyrrolidone/dimethylaminoethylacrylate copolymers (available from International Specialty Products). These compounds affect the surface tension of the formulation and so can be included in suitable quantities to produce a desired surface tension value. For coating purposes for example, it is desirable that the surface energy of the substrate is greater than the surface tension of the coating formulation, in order to achieve a smooth coating. Therefore addition of these surfactants can be used to reduce the surface tension.

The composition is suitably cationic in nature, in particular for paper and fabric treatment, to ensure that it binds the substrate strongly. It may therefore be necessary to include cationic agents. Examples of these include cationic, water-soluble acrylic copolymers having side chains attached to a vinyl backbone chain and each having at least two cationic radicals. Examples of these are described for example in U.S. Pat. No. 5,213,873. These may be represented as polymers with m recurring units of formula (I):

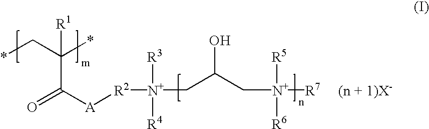

where R¹ is hydrogen or methyl, A represents —O—, or —NH—, R² is a C₂₋₄alkylene group or a group of formula —CH₂CH(OH)CH₂—, R³, R⁴, R⁵ and R⁶ are the same or different C₁₋₃alkyl groups, R⁷ is C₁₋₁₈alkyl or benzyl, n is an integer of from 1 to 3 and X is a balancing anion such as chloride. Another example is sold under the tradename CP-261-LV and is supplied in admixture with silicas by Grace Davison, but other cationic agents would be apparent to the skilled person.

A particularly preferred additional ingredient is hyperbranched polyesteramides based upon anhydrides such as maleic anhydride or succinic anhydride and diisopropanolamine. These are available from DSM (Netherlands) under the tradenames TopBrane and Hybrane from DSM . They are low molecular weight, non-ionic polymers which contain hydrophilic and hydrophobic end groups and the balance between these may be varied depending desired properties of the mixture. The compounds are effective as binders and rheology control agents. An example of a typical polymer of this type is illustrated as formula (A) although variants of this structure are possible.

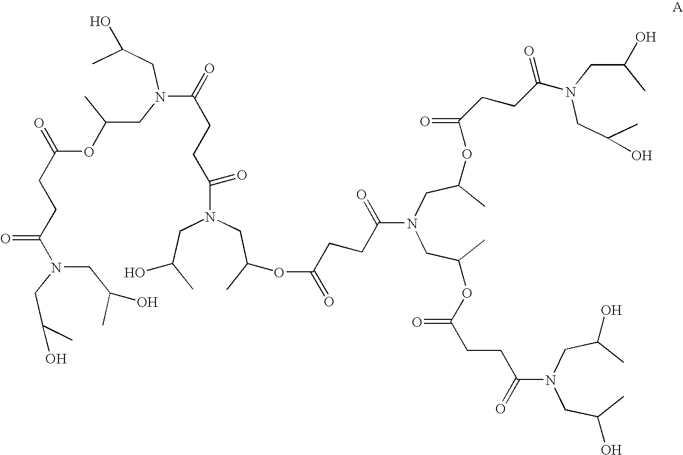

They may be used in place of many of some of the additional reagents such as dispersing agents and binders which may be conventionally employed in these compositions. Particular examples of such polymers which may be useful in the context of the present invention are sold as HyBrane S1, Hybrane P1 and Hybrane P4 from DSM. It has been found that these additives are particularly useful in paper treatment compositions, as they result in a paper which binds tightly to ink, and so reduces running and smudging.

If desired, the alumina component (b) of the composition may be infused or otherwise combined with the hyperbranched polyesteramides, prior to mixing.

In a treatment composition according to the invention, the relative quantities of the constituents will depend on the nature of the substrate to which, and manner in which, the treatment composition is to be applied and possibly on the nature of the printing process and ink with which the substrate is intended to be used.

In particular, preferred ratios of component (a) to component (b) are between 50:1 and 3:1, more preferably between 30:1 and 4:1, most preferably between 25:1 and 10:1, such as about 20:1.

A treatment composition according to the invention may be prepared in the following manner. Components (a) and (b) are used, as available, in the form of gels. The aluminium hydroxide (b) is made into an aqueous slurry. This slurry is then mixed with the silica gel, suitably in a high shear mixer, at any required temperature but conveniently at ambient temperature. The resulting suspension may then be applied directly to a substrate to be treated. The amount of water present may be adjusted to give a viscosity appropriate for the application method to be used, but will in general will be in the range of 500-100 centipoise, and preferably between 550-650 cps.

Prior to preparation of the aluminium hydroxide slurry, the component (b) may be mixed with any other desired ingredients. For example, it may be infused or admixed into a hyperbranched polyesteramide as described above.

Components (a), (b) and (c), together with any optional additives, may be mixed and stored prior to use. Immediately prior to use, ingredients such as anti-foaming or de-foaming agents may be added.

Mixing is suitably conducted adjacent the size bath or other processing equipment in which the composition is to be used. Mixing may suitably be effected using a mixing system with a viscosity and dispersion control system such as that obtainable from Fillworth Limited, Newcastle, UK.

A second aspect of the present invention provides a substrate treatment process, comprising applying to the substrate a treatment composition in accordance with the first aspect. The nature of the substrate, and the manner in which the treatment composition is applied to it, may be as described above in accordance with the first aspect of the invention.

A third aspect provides a process for the production of a treated substrate, which involves a substrate treatment process according to the third aspect. The substrate treatment step may take place at any appropriate point during the production process, ideally as a final online step if the substrate is to be coated, or more preferably (if the treatment composition is to be incorporated into the body of the substrate) in place of or in addition to an existing process step such as the application of a sizing agent. It has been found, for instance, that a treatment process according to the third aspect of the invention may successfully be applied during the production of paper using a conventional “mould-made” process (for example, by immersing the paper in a treatment composition according to the invention instead of in a conventional sizing solution), or immediately following a conventional, higher-volume “Fourdrinierprocess (as a surface coating).

A fourth aspect of the present invention provides a substrate treatment process in which the substrate is immersed in a treatment composition containing particulate SiO₂ and water, so as to embed the SiO₂ in the body of the substrate. The ability to embed rather than coat a treatment composition, as made possible by the present invention, can allow the production of surfaces with a more natural “feel” than conventionally coated substrates and with excellent ink receptivity in subsequent printing.

The treatment composition used in this method is preferably one according to the first aspect of the invention, i.e., the SiO₂ preferably has a relatively broad particle size distribution of the type described above. More preferably, the treatment composition additionally contains particulate aluminium hydroxide, also as described above, and it may also contain other ingredients such as are contained in the composition of the first aspect of the invention.

The substrate may in particular be paper and fabrics, and the preferred mode of application depends upon the particular nature of the substrate. Paper for example is typically immersed in the treatment composition during the production, for instance at the sizing stage. Fabrics may be impregnated after production. Additional treatments may be applied to the substrate, for instance subsequent coatings, including coatings in accordance with the present invention.

According to a fifth aspect of the invention, there is provided a treated substrate to which a treatment composition according to the first aspect has been applied, for instance using a substrate treatment process in accordance with the second or fourth aspect of the invention or a substrate production process in accordance with the third aspect. The treated substrate is preferably capable of supporting print resolutions of at least 1,500 dpi, more preferably at least 2,000 dpi, most preferably at least 3,000 or 4,000 or 5,000 or 6,000 dpi.

The present invention will now be illustrated by the following non-limiting examples.

### EXAMPLE 1

### Paper Treatment Composition

The following compositions may be applied to for instance a paper substrate either by embedding (for instance, by immersing 10 the paper in the composition at the sizing stage, either instead of or in addition to a conventional sizing solution) or as a coating (after the sizing step).

Composition 1

| Material | Weight %* | Solids (%) |
|---|---|---|
| (1) Water | 64.66 | |
| (2) Airvol ™ 107 | 2.54 | 2.54 |
| (3) Vinac ™ XX-210 | 10.78 | 5.93 |
| (4) CP-261-LV | 1.60 | 0.64 |
| (5) Sylojet ® A-200 | 4.47 | 1.03 |
| (6) Sylojet ® P405 | 4.65 | 4.65 |
| (7) Sylojet ® 710C | 9.3 | 9.3 |
| (8) Finnfix ™ 10 | 0.04 | 0.04 |
| (9) Ammonia (7% aqu) | 1.96 | |
| Total (1)-(9) | 100 | 24.13 |
| (10) Poly(DADMAC) | 5** | |
| (11) Aluminium hydroxide gel (Al₂O₃) | 5** | |
| (12) PVOH | 1*** | |
| (13) Harcross anti-foamer 116 FG | Up to | |
| | 0.5** | |

*Percentages are based on the pre-blended components (1)-(9) only.
**Percentages are based on the total weight of solid components (2)-(9).
***Percentage based on combined weight of poly(DADMAC) and Al₂O₃ (PVOH pre-blended with the Al₂O₃).

Airvol™ 107 is a commercially available from Air Products and Chemicals, Inc., USA. Vinac™ XX-210 is a commercially available dispersion regulating agent. Finnfix™ 10 is a cellulose derivative available from Metsa-Serla Oyj. CP-261-LV is a cationic agent available obtainable in a premix with the Sylojet components from W.R. Grace Inc., or Grace Davison (Europe).

The Sylojet® materials are commercially available silica gel formulations containing artificial amorphous SiO₂. They contain silicas having mean particle sizes of 5 μm (Sylojet® P-405) and 1 μm (710C). Sylojet® A-200 is cationic mixture of organosilane and aluminium hydroxychloride of particle size 0.3 μm (710C). They are available from W.R. Grace Inc. (USA) and Grace Davison (Europe).

The Al₂O₃ used had a modal particle size distribution in the range of 0.3 μm to 3 μm and was purchased from Kyowa Chemical Industries, Japan.

Ingredients (1)-(9) are pre-blended and subsequently mixed with a pre-blend of ingredients (10)-(12). (Components (10), (12) and (13) are optional and one or more may be omitted in other formulations.) The anti-foaming agent (13) is suitably added, according to requirements, at the point of use.

### EXAMPLE 2

### Alternative Compositions

As an alternative to components (1)-(13) in Composition 1, the following may be used:

Composition 2

| Material | Weight %* | Solids (%) |
|---|---|---|
| Water | 67 | |
| CP-261-LV | 1.65 | 0.66 |
| Sylojet ® A-200 | 4.62 | 1.06 |
| Sylojet ® P405 | 4.81 | 4.81 |
| Sylojet ® 710C | 9.62 | 9.62 |
| Hybrane S1 | 10 | 10 |
| Ammonia (7% aqu) | 2.03 | |
| | 100 | 26.15 |
| Aluminium hydroxide gel (Al₂O₃) | 5** | |

Composition 3

| Material | Weight %* | Solids (*) |
|---|---|---|
| Water | 67 | |
| CP-261-LV | 1.65 | 0.66 |
| Sylojet ® A-200 | 4.62 | 1.06 |
| Sylojet ® P405 | 4.81 | 4.81 |
| Sylojet ® 710C | 9.62 | 9.62 |
| Hybrane P1 | 10 | 10 |
| Ammonia (7% aqu) | 2.03 | |
| | 100 | 26.15 |
| Aluminum hydroxide gel (Al₂O₃) | 5** | |

Composition 4

| Material | Weight %* | Solids (%) |
|---|---|---|
| Water | 67 | |
| CP-261-LV | 1.65 | 0.66 |
| Sylojet ® A-200 | 4.62 | 1.06 |
| Sylojet ® P405 | 4.81 | 4.81 |
| Sylojet ® 710C | 9.62 | 9.62 |
| Hybrane P4 | 10 | 10 |
| Ammonia (7% aqu) | 2.03 | |
| | 100 | 26.15 |
| Aluminum hydroxide gel (Al₂O₃) | 5** | |

### EXAMPLE 3

### Mould-made Paper Production (Impregnation)

An example of a paper production process in accordance with the invention is carried out as follows.

Paper is formed from a pulp in a conventional manner. It is then immersed in a size bath formulation which contains the treatment composition of Example 1, optionally together with other conventional sizing materials. This sizing composition should overall have a viscosity of between 500-1000 cps, preferably between 550 and 650 cps. Distilled or ionised water may be added to the size bath tank to compensate for evaporation from the formulation due to the heat generated by the paper making process, in order to maintain a consistent viscosity.

Post-treatment, the paper is treated conventionally, i.e., dried.

Paper formed by this process contains the treatment composition of Example 1 embedded within it. The silica appears to penetrate the paper structure. The paper typically has an extremely smooth surface which is suitable for ink jet and other types of printing. It enables a very high print quality, with good resolution and good stability, to be achieved.

This process can be used to treat paper of many different types and densities (e.g., up to around 800 g m⁻² board), and other substrates such as fabrics. A fabric would typically be impregnated with the Example 1 composition.

### EXAMPLE 4

### Mould-made Paper Production (Coating)

Mould-made paper may be coated with the treatment composition of Examples 1 and 2 either as a final step in its production or post-production. The composition is applied onto one or both of the paper surfaces, using conventional size rollers or reverse gravure equipment. Again the end product is suitable for ink jet and other printing processes, and enables an extremely high print quality to be achieved.

The treatment composition is typically applied to an optimum coat weight of 10 g/m², although this will depend on requirements.

Fabrics and other substrates may be coated with the treatment composition of the invention in analogous fashion.

1. A substrate treatment composition comprising a particulate substrate treating agent other than precipitated calcium carbonate, wherein the particles of the substrate treating agent have a broad range of diameters and include at least some particles with a diameter greater than 0.9 μm and at least some particles with a diameter less than 0.5 μm.

2. A substrate treatment composition according to claim 1 wherein at least some particles have a diameter greater than 1 μm.

3. A substrate treatment composition according to claim 1 or claim 2 which further comprises at least some particles with a diameter of between 0.5 and 0.9 μm.

4. A substrate treatment composition according to any one of the preceding claims wherein the particle size distribution is a multi-modal size distribution comprising two or more distinct peaks due to separate populations of particles having different average and/or maximum diameters.

5. A substrate treatment composition according to claim 4 wherein the multi-modal size distribution of the particles has at least three distinct peaks.

6. A substrate treatment composition according to any one of the preceding claims wherein the substrate treatment agent comprises silica, an organosilane, aluminium oxide Al₂O₃ or hydrated forms thereof, (and in particular aluminium hydroxide, Al(OH)₃) or mixtures thereof.

7. A substrate treatment composition according to claim 6 wherein the substrate treatment agent comprises silica.

8. A substrate treatment composition according to claim 6 or claim 7 wherein the substrate treating agent comprises aluminium hydroxide.

9. A substrate treatment composition according to any one of claims 6 to 8 which includes at least three populations of particles, which have maximum or mean diameters of (i) between 1.2 and 10 μm, (ii) between 0.5 and 1.2 μm, and (iii) between 0.2 and 0.5 μm.

10. A substrate treatment composition according to claim 8 wherein the aluminium hydroxide has a mean particle diameter of between 0.01 and 3 μm.

11. A substrate treatment composition according to any one of the preceding claims which comprises (a) particulate silica, (b) particulate aluminium hydroxide and (c) water.

12. A substrate treatment composition according to any one of the preceding claims which further comprises a binder.

13. A substrate treatment composition according to claim 12 wherein the binder is polyvinylalcohol (PVOH), photographic gelatin, or acrylic latex.

14. A substrate treatment composition according to claim 13 wherein the binder is PVOH.

15. A substrate treatment composition according to claim 14 wherein the amount of PVOH is less than 1% w/w.

16. A substrate treatment composition according to any one of the preceding claims which is substantially or completely free of organic solvents.

17. A substrate treatment composition according to any one of the preceding claims which further comprises a hyperbranched polyesteramide.

18. A substrate treatment composition according to any one of the preceding claims which further comprises a cationic reagent.

19. A substrate treatment composition according to any one of the preceding claims which further comprises one or more viscosity regulator, anti-foaming agent, dispersion regulator, dye fixing mordant and/or stabiliser.

20. A substrate treatment composition according to any one of the preceding claims which further comprises a cationic surfactant.

21. A substrate treatment process, comprising applying to a substrate a treatment composition in accordance with any one of the preceding claims.

22. A process according to claim 21 wherein the substrate is paper, natural or synthetic fabric, plastics films or glass.

23. A process according to claim 21 or claim 22 wherein the substrate is intended for use in printing.

24. A process according to any one of claims 21 to 23 wherein the substrate treatment composition is incorporated into, or embedded in, the body of the substrate.

25. A process according to any one of claims 21 to 24 wherein the composition is applied to a substrate during the substrate manufacturing process.

26. A process according to any one of claims 21 to 25 wherein the substrate is paper, and the substrate treatment composition is applied instead of a conventional paper sizing composition.

27. A process according to any one of claims 21 to 26 wherein the substrate treatment composition is applied to the substrate in a separate, subsequent treatment process.

28. A process for the production of a treated substrate, which involves a substrate treatment process according to any one of claims 21 to 27.

29. A substrate treatment process in which a substrate is immersed in a treatment composition containing particulate SiO₂ and water, so as to embed the SiO₂ in the body of the substrate.

30. A process according to claim 29 wherein the treatment composition used in this method is a silica composition according to any one of claims 1 to 8 or 10 to 21.

31. A treated substrate to which a treatment composition according to any one of claims 1 to 21 has been applied.

32. A method of preparing a substrate treatment composition according to claim 11, which process comprises forming component (b) into an aqueous slurry, and mixing the slurry with a gel of component (a).
